(19) United States
(12) Patent Application Publication
(10) Pub. No.: US 2005/0237197 A1
(43) Pub. Date: Oct. 27, 2005

(54) Detection of articles having substantially rectangular cross-sections

(76) Inventors: Howard H. Liebermann, Succasunna, NJ (US); Ernest D. Buff, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 10/831,279

(22) Filed: Apr. 23, 2004

(51) Int. Cl. G08B 13/14

(52) U.S. Cl. 340/572.6; 428/832.1; 428/928

(57) ABSTRACT

A glass-coated article having substantially rectangular cross-section is excited using a tickler magnetic field. Harmonics of the a.c. magnetic field that are thusly caused to emanate from said article are detected by either magnetic field sensing coils or by mixing with a propagating radio frequency field. A portal design ensures the detection of the glass-coated article having substantially rectangular cross-section, no matter its spatial orientation. Teachings of the instant invention are critical for the use of glass-coated articles having substantially rectangular cross-section in a number of applications that include but are not limited to anti-theft systems; monitoring of tamper-proof packages; tracking, tracing and identification of currency, secure documents, drivers licenses, and passports; tracking of personnel, labels and paper products, merchandising items, and composites; monitoring movement of textiles including clothing and garments and materials used to make said textiles containing the invention; authentication and brand theft protection, credit card verification and protection against fraud; biometrics and other medical applications.

### BACKGROUND OF THE INVENTION

1. Field of the Invention

This invention relates to remote detection of articles having substantially rectangular cross-sections; and more particularly to a method and apparatus wherein ferromagnetic metallic glass-coated articles are detected remotely by sensing the harmonic frequencies of an alternating magnetic field that emanates from an article having a substantially rectangular cross-section.

2. Description of the Prior Art

Amorphous and nanocryastalline alloy-cored glass-coated wire and its production have been disclosed in the technical and patent literature: Horia Chirac, “Preparation and Characterization of Glass Covered Magnetic Wires”, Materials Science and Engineering A304-306 (2001) pp. 166-171], U.S. Pat. No. 6,270,591 to Chiriac et al., and U.S. Pat. No. 5,240,066 to Gorynin. Without exception, all disclosures of these kinds of materials refer to articles having round cross-sections. Magnetic methods have been used to detect the presence of both substantially rectangular amorphous alloy articles that do not have a glass coating [U.S. Pat. No. 4,484,184 to Gregor et al.] and of amorphous alloy microwire (circular cross-section) both with [U.S. Pat. No. 6,441,747 to Antonenco] and without [U.S. Pat. No. 5,921,583 to Matsumoto; U.S. Pat. No. 4,660,025 Humphrey] glass coating. Indirect methods for the detection of glass-coated amorphous alloy wire have been disclosed as well [U.S. Pat. No. 6,137,41 to Tyren; U.S. Pat. No. 6,232,879; U.S. Pat. No. 6,225,905].

Greater detection distance for various configurations of ferromagnetic elements has been demonstrated by Tyren using radio frequency-based technology; see, for example: U.S. Pat. No. 6,137,411; U.S. Pat. No. 6,232,879; U.S. Pat. No. 6,225,905. A limitation of these disclosures, again, is that detection is limited to an article comprised of either a single amorphous wire or a plurality thereof. The detection of glass-coated ferromagnetic articles having substantially rectangular cross-sections is not addressed by Tyren.

The use of certain soft magnetic alloys and of glass-coated amorphous metallic alloy microwire or of articles made therefrom in anti-theft system applications, for example, has broadly been based on the sensing of a magnetic output from the article, while being excited with an a.c. magnetic field. Sensing of output is typically achieved by utilizing a magnetic pick-up coil. For example, in U.S. Pat. No. 4,484,184 to Gregor et al. there is disclosed a magnetic excitation system in combination with a magnetic output pick-up means. Just a few years later, a much more thorough analysis of magnetic output in such a system is given in U.S. Pat. No. 4,660,025 to Humphrey, in which details of the magnetic harmonics generated are given. To this day, the measurement of magnetic output is the most widespread method used in anti-theft systems. While effective to a certain extent, prior art technologies are limited in terms of both orientation-dependent sensitivity and also distance over which detection of the article is possible. The orientation-dependence of the article being sensed arises predominantly from both the high geometric aspect ratio of that article and also from the directionality of the magnetic field used to drive said article. The limited sensing distance of prior art technologies stems from the rapid decrease of magnetic field with distance from its source: magnetic field decreases as an inverse exponent of distance. These two factors clearly limit the utility and effectiveness of prior art technologies.

Accordingly, there exists a need in the art for an apparatus that remotely detects the presence of glass-coated ferromagnetic articles having substantially rectangular cross-section. Also needed are detection systems that offer improved performance. Such systems, if present would open possibilities of much greater opportunities and markets than presently exist for articles having a simple wire shape.

### SUMMARY OF THE INVENTION

The present invention provides a means for detecting the presence of a soft magnetic article within an interrogation zone of an electronic article surveillance system. When compared to conventional systems, the orientation dependence of the article being detected is greatly diminished. In addition, the distance from which an article can be sensed reliably is much greater than that of conventional systems. A “tickler” magnetic field having alternating direction is applied to the article which, in turn, causes the article to become magnetized alternately as well. The directional sensitivity of the article being detected is mitigated either through article configurational considerations or by engineering the manner in which the “tickler” magnetic field is applied to excite the article.

A magnetic field is detected either directly, using a variety of magnetic methods, or indirectly by causing the emanating magnetic field to modify a traveling radio frequency (RF) or other field. Detection of articles is readily accomplished using the articles' substantially rectangular cross-section (binary function), or by reading of multi-bit (encoded) data associated therewith. As a result, the method and means of this invention are especially well suited for detection of glass-coated articles associated with a wide variety of applications, including anti-theft systems; monitoring of tamper-proof packages; tracking, tracing and identification of currency, secure documents, drivers licenses, and passports; tracking of personnel, labels and paper products, merchandising items, and composites; monitoring movement of textiles including clothing and garments and materials used to make said textiles containing the invention; authentication and brand theft protection, credit card verification and protection against fraud; biometrics and other medical applications.

Installation of the instant invention is much simpler and operation much more forgiving than with conventional systems. Accordingly, when compared with conventional systems, the system of the present invention is less expensive to construct, easier to install and use, and more reliable in operation.

### BRIEF DESCRIPTION OF THE DRAWINGS

The invention will be more fully understood and further advantages will become apparent when reference is had to the following detailed description and the accompanying drawings, in which:

FIG. 1 is a perspective view showing an example of a substantially rectangular glass-coated article with an electrical conductor winding through which electrical current is caused to flow and to thereby result in an ac tickler magnetic field for excitation of said article;

FIG. 2 is a schematic representation of a magnetic detection system for sensing the harmonics associated with the ac magnetic field emanating from the article, and resulting from the ac tickler magnetic field that is applied to the article;

FIG. 3 is a schematic representation of a compound detection system for sensing the harmonics associated with the ac magnetic field emanating from the article, and resulting from the ac tickler magnetic field that is applied to the article;

FIG. 4 shows output data plots pertaining to detection with a compound system for the case of (a) no article present, (b) article within the scope of the invention present; and

FIG. 5 is a perspective view of a portal in which either a magnetic or a compound detection system operates effectively, regardless of article orientation in space.

### DETAILED DESCRIPTION OF THE INVENTION

As used herein, the term “amorphous metallic alloy” means a metallic alloy that substantially lacks any long-range order and is characterized by x-ray diffraction intensity maxima that are qualitatively similar to those observed for liquids or oxide glasses. By way of contrast, the term “nanocrystalline metallic alloy” pertains to those metallic alloys having constituent grain sizes on the order of nanometers.

The term “glass”, as used throughout the specification and claims, refers to an inorganic product of fusion that has cooled to the solid state without crystallizing, or to glassy materials formed by chemical means such as a sol-gel process, or by “soot” processes, both of which are used to form glass preforms that are used in fiber optic processing. These materials are not fused; but rather are consolidated at high temperatures, generally below the fusion temperatures of the constituents in question.

The term “microwire”, as used herein, means an article that is present as a single element or as multiple elements, and comprises at least one metallic material.

The term “article”, as used herein, refers to a long geometric body having any number of cross-sectional shapes, including circular (wire, rod, ribbon, fiber, etc.).

The term “substantially rectangular”, as used throughout the specification and claims, refers to an article having thickness-to-width ratio ranging from nearly 1 to over 100.

The term “tickler magnetic field”, as used herein, refers to the ac magnetic field that is used to exite the article to be detected.

The term “harmonic”, as used herein, refers to an integer multiple of some fundamental frequency, usually that of the tickler magnetic field.

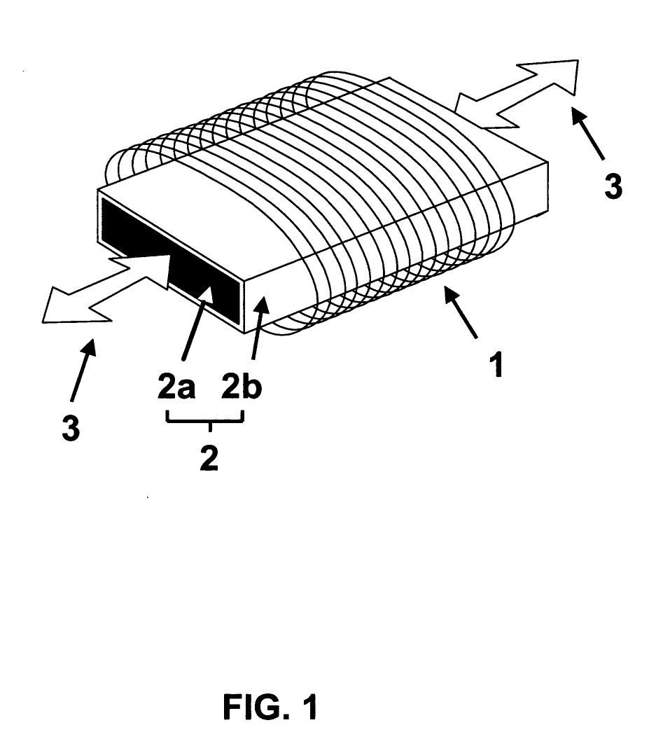

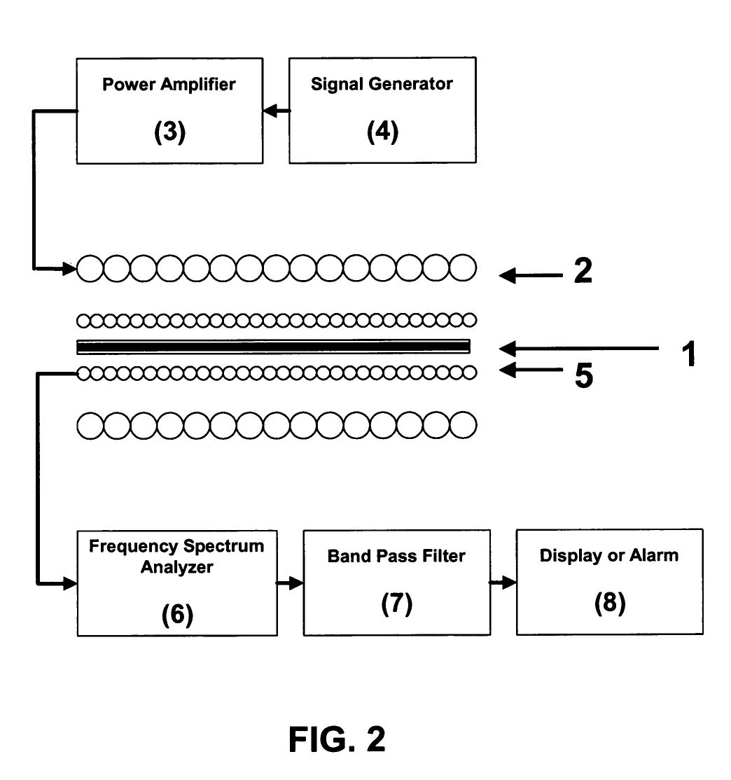

The enabler for the remote detection of ferromagnetic articles having substantially rectangular cross-section centers upon the generation of magnetic harmonic signal output by said article, while being excited by a tickler magnetic field. These induced magnetic harmonics are broadcast from either end of the article. The value of this is that any harmonic (multiple of tickler frequency) can be selected either in unison or in combination with other harmonics to provide a unique signal identity. Detection of an article of the instant invention is, in fact, detection of the magnetic harmonics that are caused to emanate from said article. FIG. 1 shows a perspective view of the use of a solenoidally wound electrical conductor 1 which, when energized with an ac electrical current, “tickles” the glass-coated substantially rectangular article 2, essentially comprised of metallic core 2a and glass coating 2b. Such tickling can clearly be achieved by means other than that shown in FIG. 1 provided the glass-coated substantially rectangular article is subjected to an ac magnetic drive field. The a.c.magnetic field 3 that is broadcast from the end of article 2 is the direct result of having tickled said article. A direct method of detection of an article's magnetic harmonics involves the use of a coil of wire, or the like, which is positioned to be intersected by the broadcast of magnetic harmonics. This, in turn, results in an induced voltage in the so-called pick-up coil, which can then be processed with conventional electronic equipment to capture signal identity data either digitally or in an analogue manner. FIG. 2 illustrates the manner by which induced magnetic harmonics can be detected and selectively processed into useful data. A glass-coated article having substantially rectangular cross-section 1 is placed into drive coil 2, and then energized using a power amplifier 3 that is driven by a signal generator 4 with alternating electrical current to produce the desired tickler magnetic field. Coaxially disposed with respect to the drive coil is the pick-up coil 5, which is used to sense the presence of an alternating magnetic field, including harmonics thereof. The electrical output from the pick-up coil is then fed into a spectrum analyzer 6, which provides a visible display of all frequency components (harmonics) comprising the resultant voltage sensed. Those specific harmonics that are of interest are selectively retained, while eliminating all other signals, using a band pass filter 7. The resulting signal can be processed in various ways, including but not limited to data logging, meters, and alarms 8. The particular configuration of electronic equipment, drive coil, pick-up coil, and so on are only for purposes of example. It is envisioned that “gates” such as those used in the interrogation zones of commercial electronic article surveillance (EAS) systems can be used just as effectively, given minor changes in system tuning. Also, the use of a pick-up coil per se is not necessarily required. A MEMs magnetometer system of the type described in U.S. Pat. No. 5,998,995 or J. L. Lamb et al. Mater. Res. Soc. Symp. Proc. 605. p. 211 (2000), the disclosures of which are expressly incorporated herein by reference thereto, could be used just as effectively. A variety of other kinds of magnetometers, including those based upon nanotechnology, could also be employed.

Given totally magnetic systems, such as those described above, there is limited detectability resulting from the very rapid drop-off in amplitude of the harmonics-containing magnetic field emanating from the ends of the glass-coated article having substantially rectangular cross-section during its tickling by the drive field. The limits governing use of such totally magnetic approaches to detection are about 4 feet and at best 8 feet if using tandem detection coil gates working in concert.

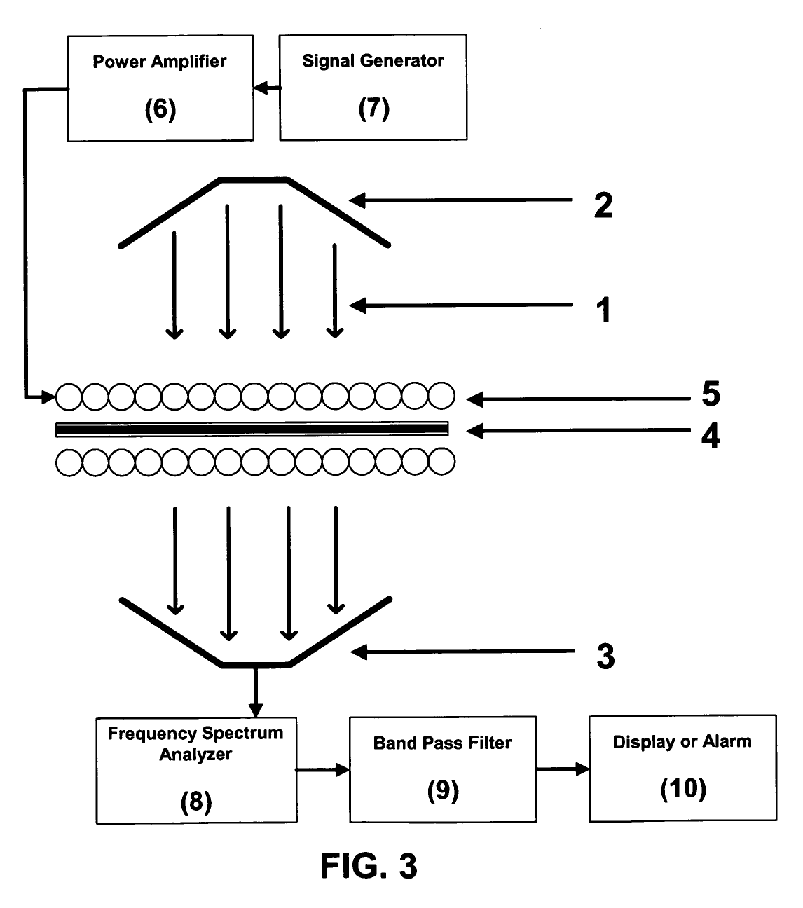

Other means by which detection could be achieved include the use of an RF field in conjunction with the magnetic field emanating from the ends of a glass-coated article having substantially rectangular cross-section. For example, the excited article is situated in the path of a propagating radio wave and causes therein a perturbance that is now carried along with radio wave. The perturbance, in fact, results in replication and mixing of the signal emanating from the excited article with the radio wave. It is the compound RF-magnetic effect that enables extended detection distances of glass-coated articles having substantially rectangular cross-sections. FIG. 3 shows a representative system for this kind of detection system. A microwave field 1 is created by a microwave source 2 and is sensed by microwave receiver 3. Glass-coated article having substantially rectangular cross-section 4 is placed into drive coil 5, and then energized using a power amplifier 6 that is driven by a signal generator 7 with alternating electrical current to produce the desired tickler magnetic field. As with the totally magnetic system described earlier, the electrical signal output of the compound system here is processed with conventional electronic devices. Specifically, a frequency spectrum analyzer 8 shows the distribution of the various wavelengths present in the signal produced by the microwave receiver. Band pass filtration 9 can be used to isolate the specific frequencies of interest. The resulting signal can be processed in various ways, including but not limited to data logging, meters, and alarms 10. Much less expensive electronics than frequency spectrum analyzers, for example, are commercially available and make this compound method of detection even more practicable. It is important to note that the compound article detection methodology disclosed here is not limited to only radio or microwaves.

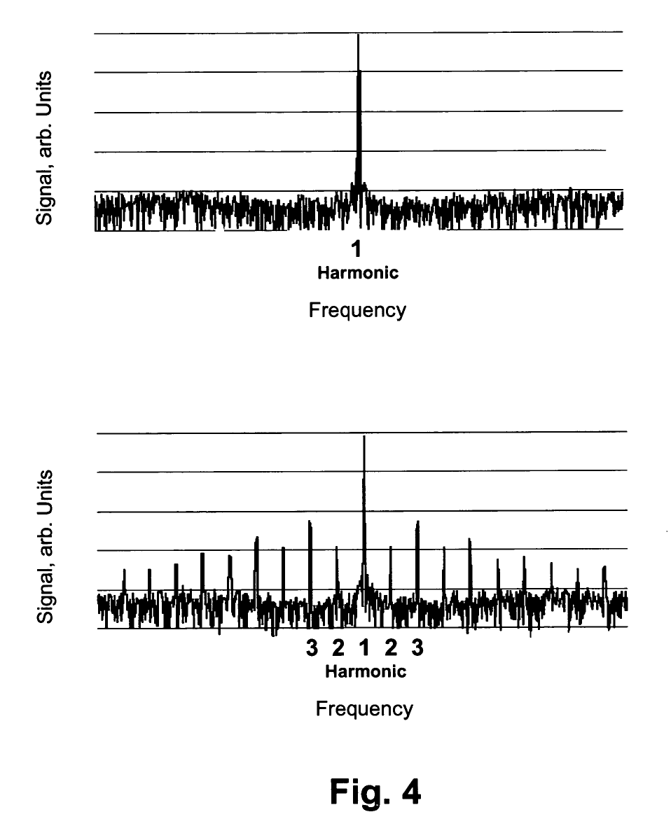

FIG. 4 shows data resulting from the use of a compound detection system. FIG. 4a depicts a signal vs. frequency plot when either no article, or an article outside the scope of this invention are subjected to test. The single, pronounced center peak 1 corresponds to that of the microwave beam used in the compound system. On the other hand, FIG. 4b shows a signal vs. frequency plot when an article of the instant invention is subject to test. Along with the same central peak seen before, there are additional satellite peaks 2, 3, etc. now present symmetrically about center. The spacing between the central peak and either of the two adjacent satellite peaks is equal to the frequency of the tickler magnetic field used. The peaks flanking the central peak are the result of the first harmonic. The next pair of symmetric peaks is the result of the second harmonic and so on. Given this kind of output and the number of harmonic peaks clearly evident, the option exists to use either single harmonics or combinations of different harmonics to provide secure identification. The fact that harmonics exist in such great numbers indicates that the option of using a very high harmonic frequency is an option. This is important since few other materials produce such a unique signal.

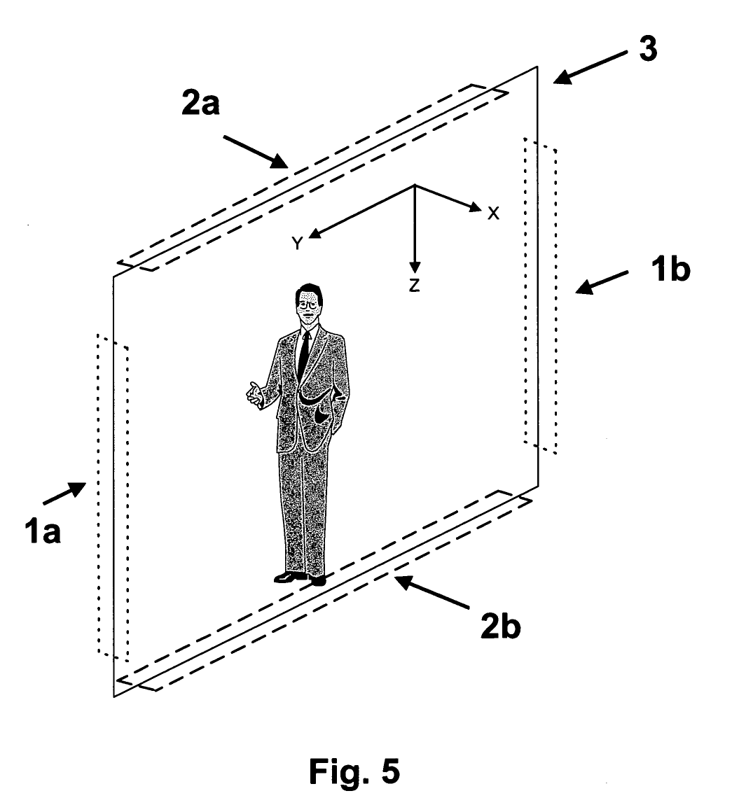

The invention also serves to overcome a limitation common to both the magnetic and the compound article detection systems, and also systems of the Prior Art. That is, a high degree of orientational sensitivity variation occurs when working with the soft magnetic properties of long slender articles. Properties improve as the long axis of the article is aligned with the direction of the magnetic drive field. Approaches by which this problem can be remedied include the use of long slender articles as an ensemble, with them in mutually orthogonal directions. Using this approach, part of at least one of the constituent long slender articles is aligned with the direction of the magnetic drive field. This approach may not be acceptable in some applications because of the ensemble's conspicuous size. An alternative approach is to have a tickler magnetization field that is made to change direction either continuously or incrementally over time. In this way, some part of the single article is in-line with the tickler magnetic field. One way in which to create a tickler field that controllably changes direction with time is to have three separately wound pairs of tickler coils, each set creating a magnetic field that is orthogonal to the tickler field created by the other two sets of coils. FIG. 5 is a perspective view showing a doorway 1 or portal in which there is created a 3-directional tickler magnetic field in the interrogation zone. Tickler magnetic field coils 2a and 2b work together to create an essentially vertical tickler field across the face of the portal; tickler magnetic field coils 3a and 3b work together to create an essentially horizontal tickler magnetic field across the face of the portal; coil 4 creates an essentially horizontal tickler magnetic field that is orthogonal to the face of the portal. When energized in sequence, the long slender article with be repeatedly and sequentially subjected to magnetic fields coming from three directions and will thereby be detectable, regardless of its orientation in space. Alternatively, the tickler magnetic field coils of the portal could be energized simultaneously rather than in sequence and each coil set would be set at a different frequency a.c. current.

Another approach to achieving direction-independent detection of an article having high dimensional aspect ratio is to mount at least three articles or groups of articles mutually orthogonally so that a significant fraction of these articles would be in-line with a unidirectional magnetic field at any time.

The teaching of the present invention can be used in conjunction with metallic alloys having various compositions, whether such alloys are amorphous, nanocrystalline, or otherwise. The present invention can also be with various kinds of glasses of which the preforms are made.

The following examples are presented to provide a more complete understanding of the invention. The specific techniques, conditions, materials, proportions and reported data set forth to illustrate the principles and practice of the invention are exemplary and should not be construed as limiting the scope of the invention.

### EXAMPLE 1

A magnetic detection system comprised essentially of two concentric wound wire solenoids was constructed, as schematically represented in FIG. 2. The magnetic tickler coil is wound onto a PVC tube that is 46 cm long and 5 cm in diameter. There are 150 turns of 1.6-mm diameter insulated copper wire wound about this tube to create the magnetic field tickler coil. The sensing coil is wound onto a PVC tube that is 7.5 cm long and 1.9 cm in diameter. There are 600 turns of 0.4-mm diameter insulated copper wire wound about this tube to create the magnetic field sensing coil. The elements of the electrical circuitry used are shown in FIG. 2. A sample to be tested for the presence and relative magnitude of magnetic harmonics is inserted into the magnetic field sensing coil, which is then inserted into the magnetic tickler field coil. For ease of handling, glass-coated amorphous microwire samples tested while affixed to a paper strip with double-stick adhesive tape. This ensures that the microwire sample to be tested remains straight at all times, and that multiple wires can be tested while being kept parallel and straight.

Using this equipment, the magnetic tickler field coil was energized with 0.14 A electrical current at 1 kHz frequency to result in approximately 50 A/m a.c. tickler field. The sample tested was three 84 mm long glass-coated microwire lengths spaced less than 1 mm apart and affixed to a piece of paper with double sided adhesive tape. The microwire of this sample had a Pyrex coating of about 6 μm thickness and a 25 μm diameter amorphous alloy core of nominal chemistry Fe_{77.5}B₁₅Si_{7.5}. Harmonics having frequencies of multiples of the 1 kHz magnetic tickler field were observed using a lock-in amplifier. This demonstrates the principle of magnetically detecting the presence of glass-coated microwire that is magnetically tickled. Similar performance is expected with substantially rectangular glass-coated articles having amorphous alloy compositions in the 75≦Fe≦82 at. %, 0≦Co≦10 at. %, 10≦B≦20 at. %, 0≦Si≦10 at. %, and 0≦C≦4 at. %.

### EXAMPLE 2

Following the same procedures and using the same equipment as in Example 1, a glass-coated microwire with an amorphous alloy core having nominal chemistry CO_{68.18}Fe_{4.32}B₁₅Si_{12.5} was tested using the magnetic detection system. No harmonics were observed when subjected to the same test protocol as before. It is believed that this difference in performance between the two glass-coated amorphous alloy microwire samples tested is related to the magnetic domain structure of these two kinds of microwire. In the case of the Fe_{77.5}B₁₅Si_{7.5} glass-coated microwire, the magnetic domain structure is comprised of a single domain aligned along the center of the microwire, surrounded by a torus of small, radial domains of alternating polarity. In contrast, the CO_{68.18}Fe_{4.32}B₁₅Si_{12.5} glass-coated microwire is comprised of a magnetic center that is not aligned along the center of the microwire. An important distinction between these two kinds of domain structures is that the Fe_{77.5}B₁₅Si_{7.5} sample has a significant material volume of magnetization that is oriented along the test (magnetic tickler field) direction. Thus, even without the benefit of having the axially oriented domains in the torus surrounding the central domain participate in the magnetization process, there is sufficient volume of favorably oriented magnetic domain in the central part of the microwire. In contrast, neither the central nor the torus domains of the CO_{68.18}Fe_{4.32}B₁₅Si_{12.5} glass-coated amorphous alloy microwire are favorably oriented (axially) with respect to testing direction of the microwire.

### EXAMPLE 3

Glass-coated amorphous alloy microwire samples were prepared by affixing four 7.5 cm lengths spaced about 1 mm apart onto a paper substrate using double-sided adhesive tape. This sample was then taken to the Flanders, N.J. Blockbuster store, in which Sensormatic electronic article surveillance gates are installed. I was given permission to do some testing with this magnetic detection system. The sample prepared was found to sound the alarm whenever the microwires therein were held simultaneously horizontally and perpendicular to the direction of walking through the Blockbuster detection gate. It was found, however, that that alarm was not sounded when the sample deviated by more than about 30 degrees from the orientation just described. An important result of this example is that a commercial magnetic detection system, even though not optimized for the detection of glass-coated amorphous microwire, was successful in detecting the presence of a sample made up of microwire lengths. Furthermore, the observation of detection capability dependence on angular disposition of the sample is similar to that observed when using commercial anti-theft tags.

### EXAMPLE 4

A sample identical to that used in Example 3 was prepared, except that the inner of the glass-coated amorphous alloy had a nominal chemistry of CO_{68.18}Fe_{4.32}B₁₅Si_{12.5}. As with concentric solenoid system for magnetic detection used in Examples 1 and 2, the present sample never set off the Blockbuster alarm, no matter its orientation or proximity to the antennae that generate the magnetic field of the anti-theft system.

### EXAMPLE 5

A compound detection system consists essentially of two basic components: a magnetic tickler field generating device, and a radio frequency (RF) transmitter/receiver pair, as schematically shown in FIG. 3. The magnetic tickler field-generating device can take on a number of forms, including that of a conventional solenoid, a flat (pancake) coil, and others. In the present Example, a pancake coil was used to generate the tickler magnetic field of 500 Hz emanating out if its surface. The RF source was used to transmit microwaves having a frequency of 2.5 GHz. An example of the output from this transmitted microwave beam is shown in FIG. 4a, in which only a single, well-defined peak is observed at 2.5 GHz 1. Compound detection occurs when a sample under test is tickled magnetically while in the presence of the RF field, which was targeted in the general direction of the sample under test and then the mixed signal (magnetic plus RF) picked up using a receiver antenna. A single 7.5 cm length of glass-coated amorphous microwire having a core with nominal composition CO_{68.18}Fe_{4.32}B₁₅Si_{12.5} positioned perpendicular to the magnetic tickler field pancake coil was tested and gave the results shown in FIG. 4b. Note that the original peak 1 corresponding to the microwave carrier frequency remains even in the presence of the sample being tested. Significantly though, there are multiple satellite peaks symmetrically disposed about this RF peak. The spacing between peaks is equal to the magnetic tickler frequency. The first of these satellite peaks 2 corresponds to the frequency of the RF signal plus that of the magnetic field to the right of center, and frequency of the RF signal minus that of the magnetic field to the left of center. The generation of harmonics results in further peaks as well, each separated from the next by an amount equal to the frequency of the tickler magnetic field. One of the prominent advantages of a compound detection system over a magnetic detection system is that of detection distance. That is, a much wider interrogation zone can be realized with a compound detection system. Similar performance is expected with substantially rectangular glass-coated articles having amorphous alloy compositions in the 30≦Co≦70 at. %, 2≦Fe≦6 at. %, 2≦Ni≦40 at. %, 0≦Mo≦5 at. %, 0≦Mn≦5 at. %, 0≦B≦20 at. %, 0≦Si≦10 at. %, and 0≦C≦4 at. %.

### EXAMPLE 6

Following the same procedures and using the same equipment as in Example 5, a paper clip, scissors, and other common metallic objects were subjected to testing, but no harmonics were observed. The data plots resulting from these tests were identical to that shown in FIG. 4a, which shows only the RF peak 1. These results demonstrate the importance of using glass-coated amorphous microwire for detectability in compound detection system.

### EXAMPLE 7

Following the same procedures and using the same equipment as in Example 5, a single 7.5 cm length of glass-coated amorphous microwire having a core with nominal composition CO_{68.18}Fe_{4.32}B₁₅Si_{12.5} is positioned parallel to the magnetic tickler field pancake coil. While the results looked similar to those shown in FIG. 4b, the amplitude of the satellite peaks was greatly diminished, nearly imperceptible. This is the result of magnetostatic energy effects. That is, the ability of a body to become magnetized by an applied magnetic field depends on the geometric aspect ratio of the body being magnetized. Maximum magnetization for a give body shape and given applied magnetic field occurs when that applied field is directed along the longest dimension of that body. Therefore, in the present Example, the glass-coated amorphous microwire was positioned parallel to the magnetic tickler field pancake coil, or perpendicular to the magnetic tickler field, with the longest dimension of the microwire perpendicular to the tickler magnetic field.

### EXAMPLE 8

A portal having a 2 meter×2 meter opening was constructed with three independent sets of tickler magnetic field coils, as shown schematically in FIG. 5. Whereas the x-plane coil 3 is largely sufficient to ensure the magnetic tickling of glass-coated microwire and even of conventional EAS harmonic markers, there exists a substantial likelihood for failure to detect using this tickler magnetic coil alone because its magnetic field is largely x-axis oriented. Magnetic tickler field coils 1a and 1b, in conjunction with magnetic tickler field coils 2a and 2b provide the remaining two orthogonal directions of magnetic tickler field to ensure magnetic excitation of a length of amorphous glass-coated microwire, or of conventional EAS harmonic markers. Coil 3 has about 50 turns of copper wire, whereas each of the coils 1a, 1b, 2a, and 2b has about 100 turns of copper wire. Requisite electrical current flowing through each of the coils is about 2 amperes.

In one mode of operation, each of the three coil sets is repeatedly energized in sequence for a very brief time. In another mode of operation, all tickler magnetic coils are energized simultaneously and continuously, with coil 1 being energized at one frequency of electrical current, coils 2a and 2b at another frequency of electrical current, and coils 3a and 3b at yet another frequency of electrical current. Then, suitable electronic equipment can be used to both recorded and to deconvolute the complex magnetic tickler field contributions oriented in different directions.

It is envisioned that the portal system disclosed here would be useful in both magnetic as well as in compound anti-theft systems.

### EXAMPLE 9

Using the portal system described in Example 8 in conjunction with a compound detection system, a 7 cm long article of glass-coated amorphous alloy with nominal composition CO_{68.18}Fe_{4.32}B₁₅Si_{12.5} was tested for signal output. It was found that no matter what the inclination or position within the portal, a presence of strong harmonics was consistently detected.

Having thus described the invention in rather full detail, it will be understood that such detail need not be strictly adhered to but that various changes and modifications may suggest themselves to one skilled in the art, all falling within the scope of the present invention as defined by the subjoined claims.

1. A glass-coated metallic article having substantially rectangular cross-section, and a thickness-to-width ratio ranging from nearly 1 to over 100.

2. The article of claim 1 in which the metallic core is an amorphous alloy.

3. The article of claim 2 in which the amorphous alloy core has nominal composition 30≦Co≦70 at. %, 2≦Fe≦6 at. %, 2≦Ni≦40 at. %, 0≦Mo≦5 at. %, 0≦Mn≦5 at. %, 0≦B≦0 at. %, 0≦Si≦10 at. %, and 0≦C≦4 at. %.

4. The article of claim 3 in which the amorphous alloy core has nominal composition CO_{68.18}Fe_{4.32}B₁₅Si_{12.5}.

5. The article of claim 3 in which the amorphous alloy core has nominal composition CO_{66.38}Fe_{3.82}Ni_{0.8}B₁₄Si₁₅.

6. The article of claim 3 in which the amorphous alloy core has nominal composition Ni_{43.8} CO_{30.1}Fe_{9.1}B₁₅Si₂.

7. The article of claim 2 in which the amorphous alloy core has nominal composition 75≦Fe≦82 at. %, 0≦Co≦10 at. %, 10≦B≦0 at. %, 0≦Si≦10 at. %, and 0≦C≦4 at.

8. The article of claim 6 in which the amorphous alloy core has nominal composition Fe_{77.5}B₁₅Si_{7.5}.

9. The article of claim 6 in which the amorphous alloy core has nominal composition Fe₈₀B₁₁Si₉.

10. The article of claim 6 in which the amorphous alloy core has nominal composition Fe_{80.5}B_{13.5}Si₄C₂.

11. The article of claim 1 in which the metallic core is a crystalline alloy.

12. The article of claim 11 in which the metallic core is a nanocrystalline alloy.

13. A magnetic detection system for the detection of the presence of glass-coated metallic articles using a tickler magnetic field to excite the article and magnetic pick-up coils to receive the output signal.

14. The magnetic detection system of claim 13 in which the tickler magnetic field is provided by a wound conductor solenoid or assembly of such solenoids.

15. The magnetic detection system of claim 13, in which the tickler magnetic field is provided by a flat, helically wound conductor or an assembly thereof.

16. The magnetic detection system of caim 13 in which an array or a single MEMS magnetometer is used to sense and receive the output signal.

17. The magnetic detection system of claim 13, in which an array or a single magnetometer, including those based upon nanotechnology, is used to sense and receive the output signal.

18. A compound detection system for detecting the presence of glass-coated metallic articles using a tickler magnetic field to excite the article in the presence of an RF field.

19. A compound detection system of claim 18, in which the tickler magnetic field is provided by a wound conductor solenoid or assembly of solenoids.

20. A compound detection system of claim 18, in which the tickler magnetic field is provided by a flat, helically wound conductor or an assembly thereof.

21. A portal designed to provide a tickler magnetic field in substantially all orientations to ensure orientation-independent detection of a glass-coated article having substantially rectangular cross-section.

22. A magnetic detection system for the detection of the presence of glass-coated metallic articles using a tickler magnetic field provided by the portal of claim 21 to excite the article and magnetic pick-up coils to receive the output signal.

23. A compound detection system for the detection of the presence of glass-coated metallic articles using a tickler magnetic field provided by the portal of claim 21 to excite the article in the presence of an RF field.

24. A method for detecting the presence of a glass-coated article having substantially rectangular cross-section and a metallic alloy core using a magnetic system, comprising the steps of:
a. activating a magnetic field-sensing system, whether solenoid-based, MEMS-based, or by other means;
b. activating a tickler magnetic field in the general vicinity of the magnetic field sensing system by solenoid-based, flat helix winding-based, portal, or by other means;
c. bringing a glass-coated article having substantially rectangular cross-section and a metallic core into the proximity of the tickler field;
d. receiving and electronically processing a signal from the sensing means;
e. determining whether or not a glass-coated article having a substantially rectangular cross-section is present, based on said processed signal.

25. A method for detecting the presence of a glass-coated article having substantially rectangular cross-section and a metallic alloy core using a compound system, comprising the steps of:
a. activating a radio frequency transmitter/receiver pair;
b. activating a tickler magnetic field in the general vicinity of the radio frequency transmitter/receiver means by solenoid-based, flat helix winding-based, portal, or by other means;
c. bringing a glass-coated article having substantially rectangular cross-section and a metallic core into the proximity of the tickler field;
d. receiving and electronically processing a signal from the radio frequency receiver sensing means;
e. determining whether or not a glass-coated article having substantially rectangular cross-section is present, based on said processed signal.
